(19) United States
(12) Patent Application Publication
(10) Pub. No.: US 2007/0008733 A1
(43) Pub. Date: Jan. 11, 2007

(54) Automobile auxiliary mirror

(76) Inventor: Wen Huang, Kaohsiung County (TW)

Correspondence Address: Wen Huang;No. 24, Alley 53, Lane 2, Sec. 2,, Zhongshan Road, Hunei Shiang, Kaohsiung County, 829, TW

(21) Appl. No.: 11/175,840

(22) Filed: Jul. 6, 2005

(51) Int. Cl. B60R 1/12; B60Q 1/26

(52) U.S. Cl. 362/494; 362/140

(57) ABSTRACT

An automobile auxiliary mirror includes a frame, a mirror body fixed in said frame, a first warning light and a second warning light fixed on an electronic board inside the mirror. The frame and the mirror body both have a light passing property. The first warning light is lit up in case of the subordinate light of an automobile lit up, and the second warning light is lit up in case of the indicator light lit up. So when the subordinate or the indicator light is lit up, the auxiliary mirror may at the same time shine and give vivid light for showing a vivid warning.

### BACKGROUND OF THE INVENTION

1. Field of the Invention

This invention relates to an automobile auxiliary mirror, particularly to one fixed on the surface of a rearview mirror, and the frame and the mirror body are of a light passing property. Two warning lights are provided inside the mirror, synchronously lit up respectively with the subordinate light and the indicator light of an automobile together to give vivid impression of warning.

2. Description of the Prior Art

An automobile auxiliary mirror is of a small size, generally attached on the upper surface of the rearview mirror for increasing the visible scope and reducing the dead angle area. It is only to assist viewing, having no other functions.

### SUMMARY OF THE INVENTION

This inventin has been devised to offer an automobile auxiliary mirror provided with two warning lights to light up respectively at the same time with the subordinate light and the indicator light.

The feature of the invention is the frame and the mirror of light passing property and two warning lights provided inside the mirror body. The warning light lights up together synchronously with the subordinate light and the indicator light.

### BRIEF DESCRIPTION OF DRAWINGS

This invention will be better understood by referring to the accompanying drawings, wherein:

FIG. 1 is an exploded perspective view of a first embodiment of an automobile auxiliary mirror in the present invention;

FIG. 2 is a perspective view of the first embodiment of an automobile auxiliary mirror in the present invention;

FIG. 3 is a cross-sectional view of the first embodiment of an automobile auxiliary mirror in the present invention;

FIG. 4 is a front view of the first embodiment having its warning light lit together with the subordinate light of an automobile in the present invention;

FIG. 5 is a front view of the first embodiment having its warning light lit together with the indicator light of an automobile in the present invention;

FIG. 6 is a front view of the first embodiment having its warning light lit together with the subordinate light and the indicator light in the present invention; and,

FIG. 7 is a cross-sectional view of a second embodiment of an automobile auxiliary mirror in the present invention.

### DETAILED DESCRIPTION OF THE PREFERRED EMBODIMENTS

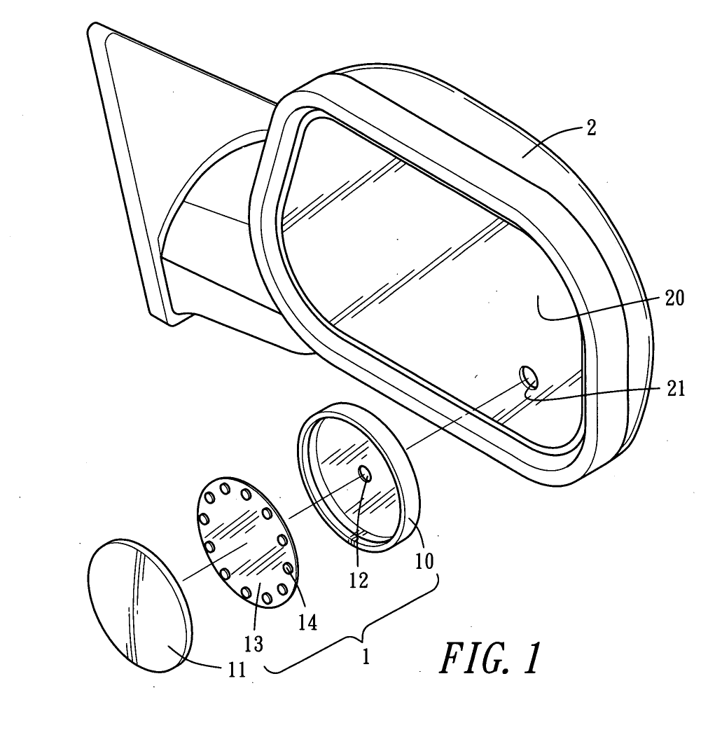

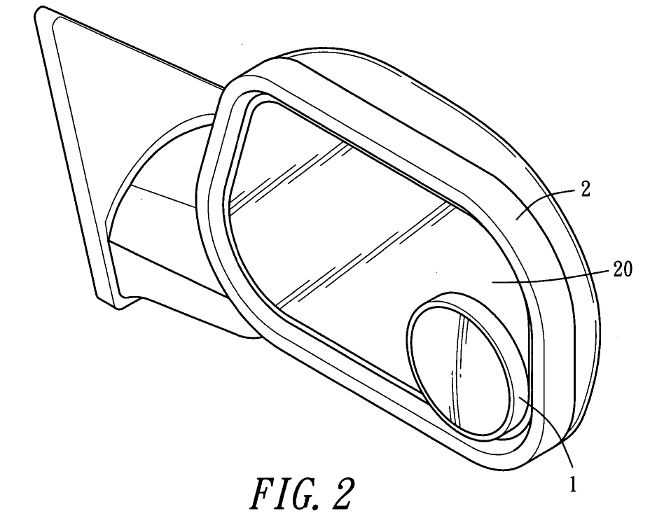

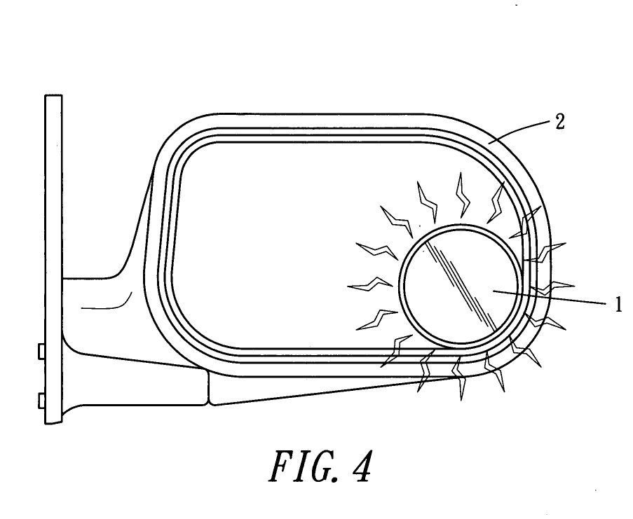

A first embodiment of an automobile auxiliary mirror in the present invention, as shown in FIGS. 1, 2 and 3, is adhered on the surface 20 of a rearview mirror 2 of an automobile, including a frame 10 of light passing property, a mirror body 11 fitted inside the frame provided with a designated section 110 (as an arrow head shown in FIG. 5) also having light passing property, and a wire hole 21 bored in the bottom side adhered to the rearview mirror 2 to match with a wire hole 21 of the mirror body 20 of the rearview mirror 2 for a power wire to extend in the interior of the mirror 1. Further, an electronic board 13 is provided in the interior of the auxiliary mirror 1, for depositing a first warning light 14 under the board 13 and a second warning light 15 on the board 13 respectively lighting synchronously with the subordinate light and the indicator light of an automobile. When the first warning light 14 is lit up, the light beam passes radially through the circumference of the circular frame 10, as shown in FIG. 4. When the second warning light 15 is lit up, its light beam passes through only the designated section 110 of the mirror body 11, as shown in FIG. 5.

In using, when the subordinate light is lit up, the first warning light 14 of the auxiliary mirror 1 is also lit up at the same time, and then the its light beam shoots out of the mirror frame 10 so that the circumference of the frame 10 will shine during nighttime, very starkly vivid to show warning impression. If the indicator light is lit up, the second light 15 is lit up at the same time, with its light beam shooting out of only the designated section 110 (shaped as an arrow head), enabling the drivers of automobiles running behind to notice the light and the moving direction of the automobile running in front of them. So when the right indicator light is lit, the designated section 110 of the auxiliary mirror 1 on the rearview mirror 2 of the automobile is shinning; in case of the left indicator light lit up, the designated section 110 of the auxiliary mirror 1 on the left rearview mirror 2 is shinning. During nighttime, if both the subordinate light and the indicator light are lit up, the auxiliary mirror 1 has its frame 10 and its designated section 110 are both shinning, as shown in FIG. 6.

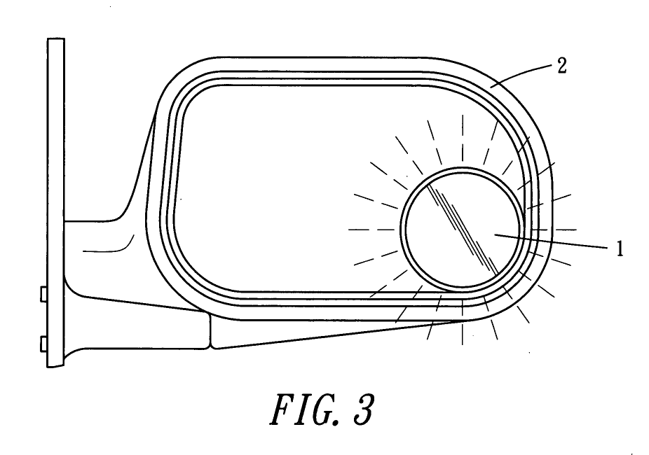

Next, the frame 10 of he auxiliary mirror 1 has its height inclined to one side, as shown in FIGS. 1 and 3, and its inclined degree can be adjusted according to necessity. Or its height may be level, as shown in FIG. 7.

In general, the frame 10 of the auxiliary mirror 1 is shinning in case of the subordinate light lit up, and the designated section 110 of the mirror body 11 is shinning in case of the indicator light lit up, so they have a vivid warning function during running of an automobile, upgrading the safety of the automobile, especially during nighttime.

While the preferred embodiment of the invention has been described above, it will be recognized and understood that various modifications may be made therein and the appended claims are intended to cover all such modifications that may fall within the spirit and scope of the invention.

What is claimed is:

1. An automobile auxiliary mirror comprising:
A frame having a light passing property;
A mirror body fixed inside said frame and provided with a designated section of a preset shape thereon, said designated section having a light passing property;
An electronic board fixed in the interior of side said frame and below said mirror body;
A first warning light fixed under said electronic board and being lit up synchronously with a subordinate light of an automobile, its light beam shooting out of said frame when said first warning light is lit up; and,
A second warning light fixed on said electronic board and being lit up synchronously with an indicator light of an automobile, its light beam shooting out of only said designated-section when said second warning light is lit up.

2. The automobile auxiliary mirror as claimed in claim 1, wherein said auxiliary mirror is fixed on a rearview mirror of an automobile, said rearview mirror has a wire hole in its mirror body on which said auxiliary mirror is fixed, and said auxiliary mirror also has a wire hole on its bottom wall adhered on said mirror body of said rearview mirror, and a wire extends in said auxiliary mirror to be connected to said electronic board.
